(19) United States
(12) Patent Application Publication
(10) Pub. No.: US 2026/0178868 A1
(43) Pub. Date: Jun. 25, 2026

(54) WIRELESS ELECTRONIC TAGS AND INSTALLATION STRUCTURES THEREOF

(71) Applicant: SHUYOU (Shanghai)Technology Co., LTD., Shanfghai (CN)

(72) Inventors: Xiaomeng Ma, SHANGHAI (CN); Jianping Liu, SHANGHAI (CH)

(21) Appl. No.: 19/426,396

(22) Filed: Dec. 19, 2025

(30) Foreign Application Priority Data
Dec. 25, 2024 (CN) 202411942850.3

(51) Int. Cl. G06K 19/077

(52) U.S. Cl. CPC G06K 19/07749

(57) ABSTRACT

A wireless electronic tag comprises a circuitry; an inner housing; a thermal insulated housing; and an outer housing comprising an upper housing and a lower housing. The circuitry is accommodated in a cavity of the inner housing. The outer housing is provided with sealing ring grooves to accommodate sealing rings, and the upper housing and the lower housing being pressed against each other to secure the sealing rings and form a seal.

### CROSS-REFERENCE TO RELATED APPLICATION

This application claims priority to Chinese Patent Application No. 202411942850.3, filed Dec. 25, 2024, the disclosure of which is incorporated herein by reference in its entirety and for all purposes.

### FIELD OF THE APPLICATION

The present application relates to the field of wireless communication, specifically, to wireless electronic tags resistant to high temperature and high pressure.

### BACKGROUND

With the development of Bluetooth Low Energy (BLE) technology, it is widely used due to its low power consumption, high-speed transmission, security, flexibility, low cost, and wide compatibility. In medical industry, electronic tags were traditionally installed on medical trays for tracking, but now efforts are being made to integrate BLE technology onto electronic tags. Electronic tags with radio-frequency identification (RFID) and BLE will have better performance, as they enable tracking and identifying the status of trays through mobile phones, as well as managing trays through internal supporting software and Bluetooth network management nodes. Conventional operating temperature for BLE circuit boards, electronic components (such as Bluetooth chips, capacitors, inductors, etc.), and batteries is −20° C.˜85° C., and during the lifecycle of medical trays, high temperature and high pressure steam sterilization and cleaning processes require reaching and maintaining a temperature of up to 136° C. and a pressure level of up to 35 pcsi, but there is no low-power Bluetooth products on the market that can withstand steam sterilization of 136° C. Further, high humidity vapor itself will corrode circuit boards and batteries, causing circuit breaking or other malfunctions. It is very important to protect BLE tags from high temperatures and from being corroded by high humidity vapors. However, most thermal insulation materials and structures only have thermal insulation effects within a few minutes in environments with good air circulation and easy heat dissipation on non-heating surfaces. Once made into a closed chamber, the insulation effects of the insulation materials are not significant when surrounded by high temperatures and unable to dissipate heat, which is not enough to keep BLE tags from being damaged.

### SUMMARY

In order to solve the above problems, the application provides a wireless tag that uses a special thermal insulation material to form a sealed structure, protecting the circuit board and electronic elements from high-temperature damage and preventing high-pressure vapor from corroding the circuit board. In addition, BLE tag installation structures being able to adapt to different trays are also provided.

In the application, the wireless electronic tag comprises a circuitry; an inner housing, the circuitry is accommodated in a cavity of the inner housing; a thermal insulated housing; an outer housing comprising an upper housing and a lower housing, the outer housing being provided with sealing ring grooves to accommodate sealing rings, and the upper housing and the lower housing being pressed against each other to secure the sealing rings and form a seal.

The outer housing is provided with two sealing ring grooves that are staggered, and two sealing rings are secured in the two sealing ring grooves.

A vertical mating surface is between the upper housing and the lower housing, with the two sealing ring grooves vertically arranged in the vertical mating surface.

The thermal insulated housing comprises an upper housing portion and a bottom cover pressed together to form a closed cavity for accommodating the inner housing.

A seam between the upper housing portion and the bottom cover of the thermal insulated housing is staggered with a seam between the upper housing and the lower housing.

A second aspect of the application provides a wireless electronic tag comprising an outer housing comprising an upper housing and a lower housing, the outer housing being provided with sealing ring grooves to accommodate sealing rings, the upper housing and the lower housing being pressed against each other to secure the sealing rings and form a seal, an inner surface of the upper housing comprising a plurality of supporters; a circuitry fixed to the plurality of supporters of the outer housing; thermal insulation media filled into a cavity of the outer housing where the circuitry is installed.

The thermal insulation media is filled in liquid form into the cavity of the outer housing, and is cured to completely wrap the circuitry.

The circuitry comprises PCB secured to the plurality of supporters.

A third aspect of the application provides an object to be tracked equipped with a wireless electronic tag of any of the preceding items.

The wireless electronic tag may be installed on the object to be tracked by being installed onto a bracket secured to the object to be tracked.

### BRIEF DESCRIPTION OF DRAWINGS

The manner in which the above recited features of the disclosure can be understood in detail, a more particular description of the disclosure may be referenced to examples. It is to be noted, however, that the appended drawings illustrate only examples and are therefore not to be considered limiting of its scope, and other equally effective examples may be within the scope of the disclosure.

FIG. 1 shows a perspective view of a BLE tag of one example of the application.

FIGS. 2a and 2b show a cross-sectional view and an exploded perspective view of a BLE tag of one example of the present application respectively.

FIG. 3a shows an outer housing sealing ring structure of one example of the present application and a partially enlarged view thereof.

FIG. 3b shows another outer housing sealing ring structure of one example of the present application and a partially enlarged view thereof.

FIG. 4 shows a cross-sectional perspective view of a BLE tag 400 of another example of the present application.

FIG. 5 shows a plot of pressure vs. time during a typical high-temperature and high-pressure steam sterilization cycle.

FIG. 6 shows a plot of temperature measured during one sterilization cycle.

FIGS. 7a and 7b show schematic diagrams of a BLE tag installation of a first example of the present application.

FIG. 8 shows a schematic diagram of a BLE tag installed onto a bracket of a second example of the present application.

FIG. 9 shows a schematic diagram of a BLE tag installed onto a bracket of a third example of the present application.

FIG. 10 shows a schematic diagram of a BLE tag installed onto a bracket of a fourth example of the present application.

FIGS. 11a and 11b show schematic diagrams of BLE tag installation of a fifth example of the present application.

### DETAILED DESCRIPTION

A detailed description of the present application will be given in conjunction with the accompanying drawings and the examples. The examples are based on the technical solution of the present application and provide detailed implementation methods and specific operating procedures, but the scope of protection of the present application is not limited to the following examples.

For the convenience of description, spatial relative terms such as “beneath”, “below”, “under”, “above”, “on”, etc. can be used here to describe the relationship between one element or characteristic relative to another element or characteristic as shown in the figures. It should be understood that spatial relative terms are intended to include different orientations of devices used or operated in addition to those shown in the figures. For example, if the device in the figures is flipped, elements described as “below” or “below” other elements or features will be oriented “above” other elements or features.

Unless otherwise defined, the technical and scientific terms used in the claims and description shall have the ordinary meanings commonly understood by those skilled in the art to which this application belongs. The terms “first”, “second”, and similar expressions used in the description and claims of this patent application do not denote any order, quantity, or importance, but are merely used to distinguish between different components. The term “a” or “an” and similar expressions do not imply a limitation of quantity, but rather indicate the existence of at least one. The terms “comprise”, “include”, and similar expressions are intended to specify that the elements or objects appearing before these terms encompass the elements or objects listed after them as well as their equivalents, and do not exclude other elements or objects. The terms “connect”, “connected”, and similar expressions are not limited to physical or mechanical connections, nor are they limited to direct or indirect connections.

### <First BLE Tag Example>

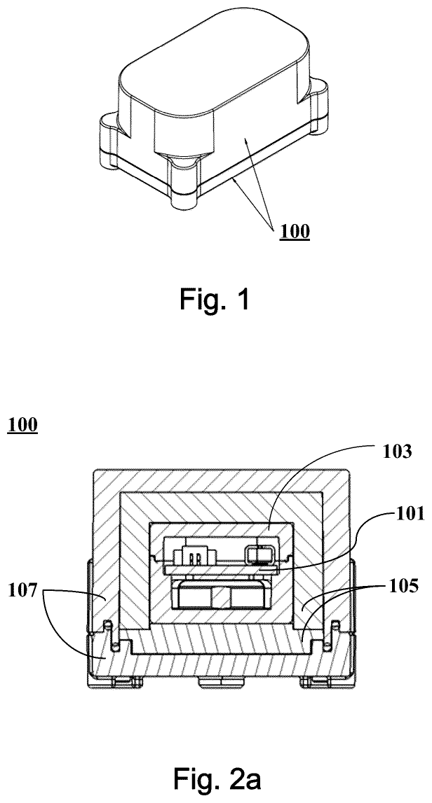

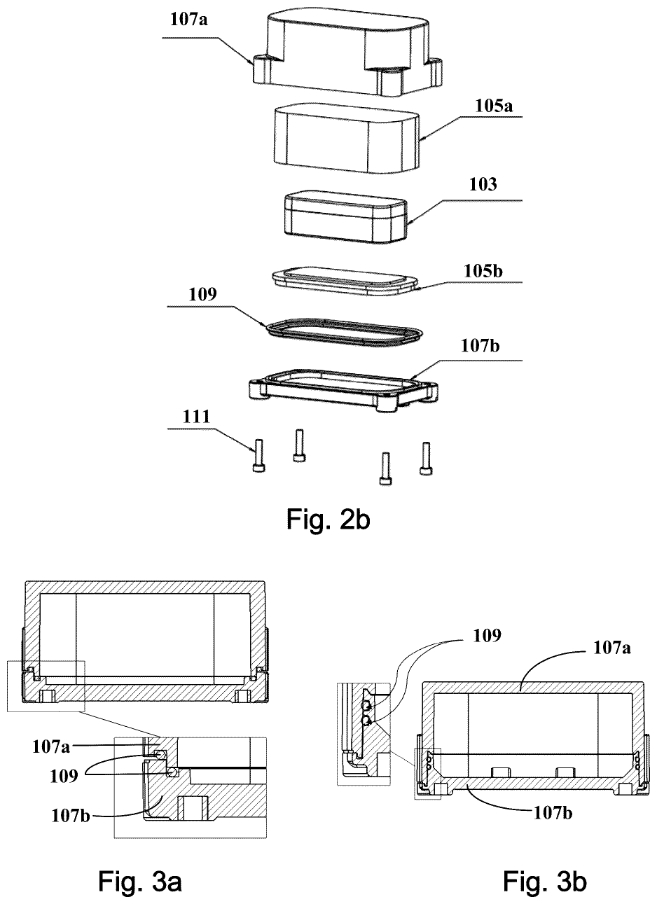

FIG. 1 shows a perspective view of a BLE tag 100 of one example of the application. FIGS. 2a and 2b show a cross-sectional view and an exploded perspective view of the BLE tag 100 of one example of the application respectively. The BLE tag 100 includes a BLE circuitry 101; it may include a printed circuit board (PCB), and electronic elements soldered onto the PCB for connection such as a BLE chip, a capacitor, an inductor, and batteries. The BLE circuitry 101 is accommodated within a cavity of an inner housing 103, the inner housing 103 is configured to support the BLE circuit system 101. The inner housing 103 may be made of plastic, and preferably, the inner housing 103 may also be made of thermal insulation material. The inner housing 103 is wrapped with a thermal insulated housing 105, which includes an upper housing portion 105a and a bottom cover 105b. The upper housing portion 105a and the bottom cover 105b form a sealed cavity for accommodating the inner housing 103 by being press-fitted to each other to form.

The thermal insulated housing 105 is made of thermal insulation material, which may be aerogel thermal insulation materials with excellent thermal insulation performance. For example, aerogel thermal insulation materials have special molecular structure and crystal structure, making the materials form porous structure and block air, thus achieving thermal insulation characteristics. When exposed to an environment of 136° C. for within 1 hour, the temperature only reaches 80° C. at most. The thickness of the thermal insulated housing 105 may be greater than or equal to 5 mm, and the thicker the thickness, the better the thermal insulation performance. Due to the fact that the thermal insulation material itself is not waterproof, water vapor may damage the structure of the thermal insulation material and reduce its thermal insulation performance. To this end, an outer housing 107 is provided outside the thermal insulated housing 105, and the outer housing 107 includes an upper housing 107a and a lower housing 107b. Sealing ring grooves are provided in the outer housing 107 to accommodate sealing rings 109, and the sealing rings 109 are secured and a seal is formed by pressing the upper housing 107a and the lower housing 107b against each other.

FIG. 3a shows an outer housing sealing ring structure of one example of the present application and a partially enlarged view thereof, and FIG. 3b shows another outer housing sealing ring structure of one example of the present application and a partially enlarged view thereof.

In FIG. 3a, the outer housing 107 is provided with two sealing ring grooves that are staggered e.g., not on the same horizontal plane) and respectively accommodate a sealing ring 109. While in FIG. 3b, there is a vertical mating surface between the upper housing 107a and the lower housing 107b, with two sealing ring grooves vertically arranged in the vertical mating surface.

Referring back to FIG. 1 to FIG. 2b, the upper housing 107a and the lower housing 107b may each include fastening mating members 111 (e.g., bolts and screw holes) to press the upper housing 107a and the lower housing 107b against each other. In order to achieve a sealing effect by compressing the sealing rings at all positions, the number of fastening mating members can be increased at any position. The outer housing 107 is preferably made of thermoplastic (e.g., PPSU).

In addition, in order to achieve a better fastening and sealing effect, a seam between the upper housing 107a and the lower housing 107b is also staggered with a seam between the upper housing portion 105a and the bottom cover 105b of the thermal insulated housing 105.

### <Second BLE Tag Example>

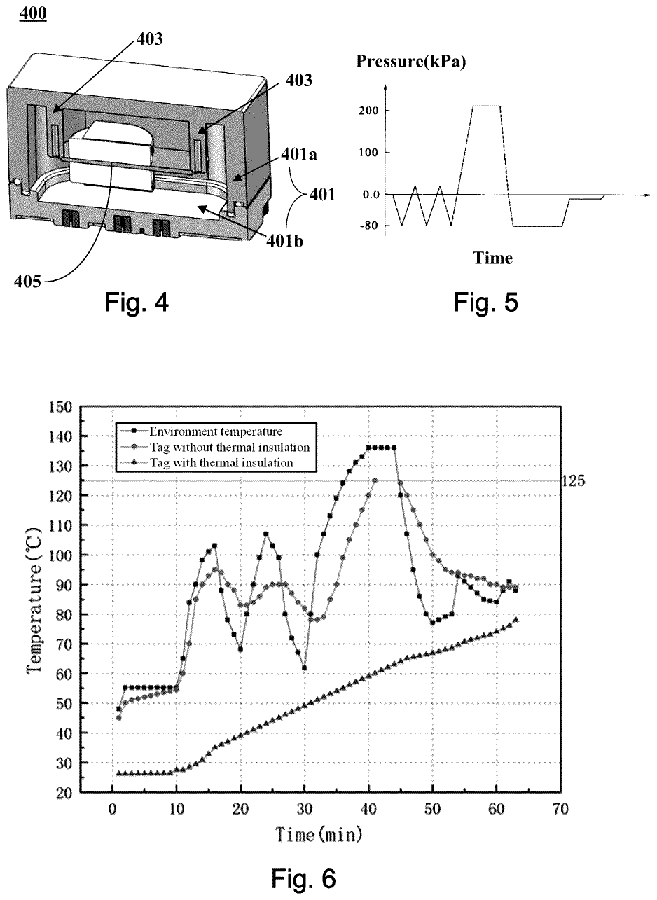

FIG. 4 shows a cross-sectional perspective view of a BLE tag 400 of another example of the present application. An outer housing 401 of the BLE tag 400 is similar as the outer housing 107 of the BLE tag 100 described with reference to FIG. 1 to FIG. 3b, including an upper housing 401a, a lower housing 401b, and sealing ring grooves for fastening sealing rings, which will not be repeated here. The difference is that an inner surface of the upper housing 401a of the outer housing 401 of the BLE tag 400 (e.g., an upper surface of the inner surface) further includes a plurality of supporters (e.g., at least two support columns 403). The support columns 403 directly contact and secure a BLE circuitry 405 of the BLE tag 400. For example, PCB of the BLE circuitry 405 may be perforated at positions corresponding to the support columns, allowing the support columns 403 to be inserted therein and secured. Alternatively, additional fasteners (such as screws) may be used to secure the PCB to the support columns 403.

Thermal insulation media may be filled into the cavity of the outer housing 401 where the BLE circuitry 405 is installed. The thermal insulation media may be filled in liquid form into the cavity of the outer housing 401 and cured at room temperature or high temperature to completely wrap the BLE circuitry 405. The BLE tag 400 may be composed by flipping the upper housing 401a upside down, securing the BLE circuitry 405 to the support columns of the upper housing 401a, filling liquid thermal insulation material, and then assembling the lower housing 401b. The thickness of the thermal insulation media wrapped on each surface of the BLE circuitry 405 is greater than or equal to 5 mm to ensure its thermal insulation performance.

FIG. 5 shows a plot of pressure vs. time during a high-temperature and high-pressure steam sterilization cycle, it is the aforementioned process of BLE tag undergo the high-temperature and high-pressure steam sterilization together with medical devices. The maximum steam pressure inside a sterilizer reaches 200 kPa (˜35 psi), and the highest temperature reaches 134° C. The entire sterilization cycle has three pre-vacuum stages in the sterilizer, expected to last for a total of 15-20 minutes. Then the pressure and the temperature gradually increase, and the sterilization stage is maintained for 5-18 minutes when the temperature and the pressure reach their maximum. Finally, there is a cooling and drying stage that lasts for about 20 minutes. The entire sterilization cycle generally lasts for about 60 minutes.

FIG. 6 shows a plot of temperature measured during one sterilization cycle. The black curve shows the environment temperature where the BLE tag is located during one sterilization cycle, the red curve shows the temperature inside the tag without thermal insulation material during one sterilization cycle, and the blue curve shows the temperature inside the BLE tag of the example of the present application during one sterilization cycle. During one sterilization cycle, the external temperature is always higher than the internal temperature of the BLE tag of the present application, and the internal temperature of the BLE tag rises slowly and reaches a maximum of 78° C. Through the entire process, the circuitry of BLE tag operates normally. If thermal insulation material is not used, the internal temperature of the tag will increase as the temperature of the sterilizer rises and decrease as the temperature of the sterilizer decreases. When the temperature exceeds 120° C., the circuitry of the tag will not work and the signal of tag will not be detected. From this, it can be seen that the BLE tag structure with the thermal insulated housing proposed by the present application protects the circuitry of BLE tag from high temperature damage or vapor erosion, expanding the application field of the BLE tag.

### <BLE Tag Installation>

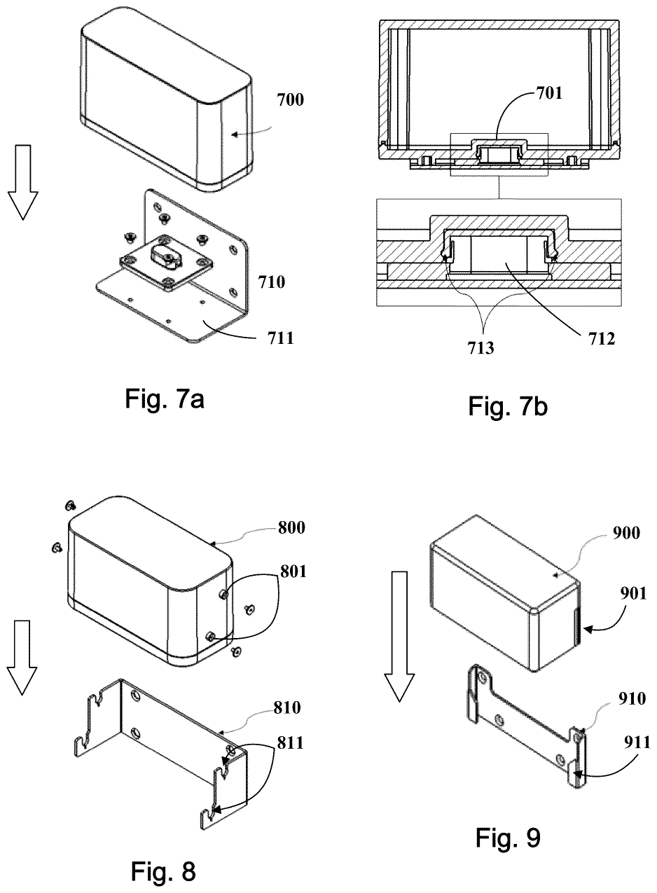

FIG. 7a shows an exploded view of a BLE tag 700 and a bracket 710, where the BLE tag 700 is installed onto the bracket 710 and then to a tray through the bracket 710. FIG. 7b shows a sectional side view and a partially enlarged view of the assembled state of a BLE tag 800 installed onto the bracket 810. A groove 701 is provided at the bottom of the BLE tag 700, and the bracket 710 includes a base 711 and a protrusion 712. During installation, the protrusion 712 is inserted into the groove 701 at the bottom of the BLE tag 700. The protrusion 712 may further include ribs 713 to assist in clamping with the groove 701. The bracket 710 may include metal and/or plastic. Various surfaces of the base 711 are provided with a plurality of holes for securing to the tray by mounting components (such as screws). In addition, a stabilizer may also be provided on a horizontal upper surface of the base 711, which may further secure the BLE tag 700 by fitting with a bottom surface of the BLE tag 700.

FIG. 8 shows a schematic diagram of a BLE tag 800 installed onto a bracket 810 of a second example of the present application. The BLE tag 800 is provided with two protruding posts 801 on two sides, where the two sides of the BLE tag 800 refer to the sides adjacent to the back side that will be attached to the bracket 810. The bracket 810 is disposed with two grooves 811 on two sides corresponding to the two sides of the BLE tag 800. During installation, the protruding posts 801 are embedded into the corresponding grooves 811 from up to down. The width at the opening of the grooves 811 is slightly smaller than the diameter of the protruding posts 801, so that the protruding posts 801 cannot easily detach from the grooves 811. The bracket 810 may be made of metal and/or plastic material. A plurality of holes are disposed at the rear side of the bracket 810 for securing to the tray using mounting components (such as screws). Further, the protruding posts 801 on the same side of the tag 800 (and correspondingly, the grooves 811 on the same side of the bracket 810) are staggered vertically to ensure that the left and right sides of the bracket 810 are evenly stressed and not easily deformed.

FIG. 9 shows a schematic diagram of a BLE tag 900 installed onto a bracket 910 of an example of the present application. Vertical sliding grooves 901 are provided respectively at area of the left and right sides of a BLE tag 900 near the back side, where the left and right sides of the BLE tag 900 refer to the sides adjacent to the back side that will be fit to the bracket 910. The bracket 910 has five sides: left front side, right front side (the left front side and the right front side are referred to as front side collectively), left side, right side, and rear side. The left and right sides of bracket 910 are perpendicular to the front and rear sides, and the left front side and right front side are provided with sliding rails 911, respectively. During installation, two vertical sliding grooves 910 of the tag 900 are inserted into the two sliding rails 911 of the bracket 910 from up to down, respectively. A plurality of holes are disposed at the rear side of the bracket 910 for securing to the tray using mounting components (such as screws). The upper edges of the sliding rails can be set as sloping edges, making it easy to install the tag 900 onto the bracket 910.

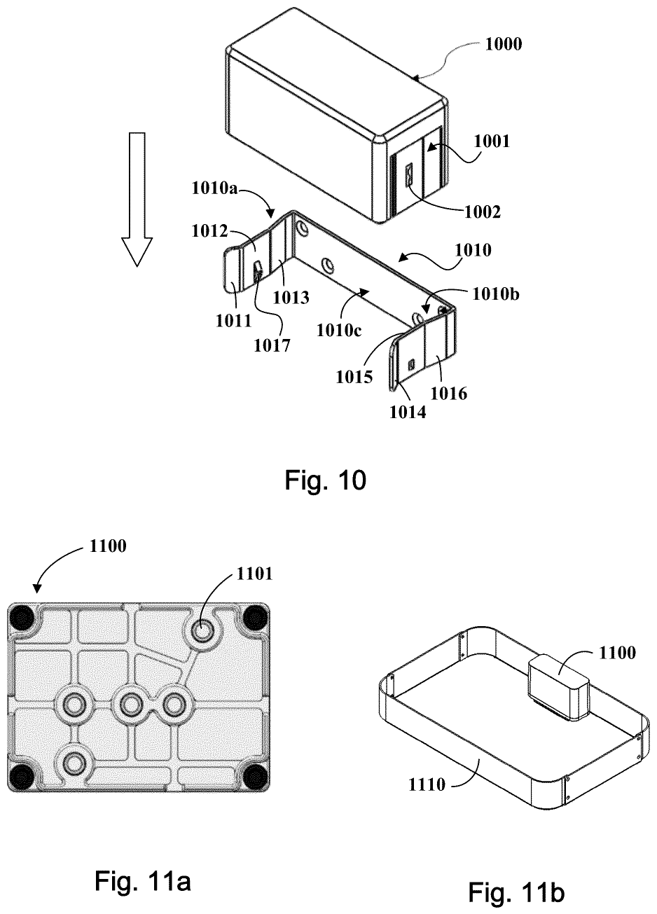

FIG. 10 shows a schematic diagram of a BLE tag 1000 installed onto a bracket 1010 of an example of the present application. The left and right sides of the BLE tag 1000 are respectively provided with shallow rectangular grooves 1001, where the left and right sides of the BLE tag 1000 refer to the sides adjacent to the back side that will be fit to the bracket 1010. The bracket 1010 consists of left wing 1010a, right wing 1010b, and rear side 1010c. The left wing 1010a of the bracket 1010 consists of a warping surface 1011, a rectangular straight surface 1012, and a warping surface 1013 in sequence, and the right wing 1010b of the bracket 1010 consists of a warping surface 1014, a rectangular straight surface 1015, and a warping surface 1016 in sequence. The rectangular grooves 1001 on the left and right sides of the BLE tag 1000 are provided with recesses 1002, and correspondingly, the inner side of the rectangular straight surface of each of the left wing 1010a and the right wing 1010b are provided with protrusion 1017 respectively. Those skilled in the art should understand that the recesses on the BLE tag 1000 and the protrusions on the bracket 1010 can be formed in any mating manner. The rectangular straight surfaces 1012 and 1015 form a 90° angle with the rear side 1010c respectively, the warping surfaces 1013 and 1016 form a 60°-70° angle with the rear side 1010c respectively, and the warping surfaces 1011 and 1014 form a 110°-120° angle with the rear side 1010c respectively. During installation, the tag 1000 is inserted into the bracket 1010 from front to back, so that the rectangular straight surface 1012 of the left wing 1010a and the rectangular straight surface 1015 of the right wing 1010b of the bracket 1010 are tightly fitted with the rectangular grooves 1001 on the left and right sides of the BLE tag 1000, and the protrusions on the left wing 1010a and the right wing 1010b are further embedded into the recesses on the left and right sides of the BLE tag 1000, respectively. A plurality of holes are disposed at the rear side of the bracket 910 for securing to the tray using mounting components (such as screws).

FIGS. 11a and 11b show schematic diagrams of BLE tag installation of an example of the present application. In which, FIG. 11a shows a bottom view of a BLE tag 1100, and FIG. 11b shows a side perspective view of the BLE tag 1100 installed on a tray 1110. The bottom surface of the BLE tag 1100 is provided with a plurality of securing holes 1101, and the spacing between each securing hole 1101 is designed in combination according to the hole spacing of tray 1110 (not shown in the figure), so that the bottom area of the BLE tag 1100 may be maximally utilized, and the arrangement of the securing holes 1101 thereof may be adapted to trays with various hole spacings.

Thus, a wireless electronic tag and its installation have been described. The circuitry of the tag can be protected from high temperature damage and prevent high-pressure vapor from corroding the circuit board by providing a wireless electronic tag with a sealed and thermal insulated structure. Further, installation structures for wireless electronic tags adapt to different trays are also provided.

It should be understood that the foregoing description is illustrative rather than restrictive. The above-described examples may be combined with one another. Numerous modifications may be made to adapt particular situations or materials to the teachings of the various examples without departing from the scope thereof. While the dimensions and types of materials described herein are intended to define the parameters of the various examples, the examples are by no means restrictive but are rather exemplary examples. Many other examples will be apparent to those skilled in the art upon reviewing the above description. The scope of the various examples should, therefore, be determined with reference to the appended claims, along with the full range of equivalents to which such claims are entitled.

1. A wireless electronic tag, comprising:
an inner housing;
a circuitry accommodated in a cavity of the inner housing;
a thermal insulated housing; and
an outer housing comprising an upper housing and a lower housing, the outer housing being provided with sealing ring grooves to accommodate sealing rings, and the upper housing and the lower housing being pressed against each other to secure the sealing rings and form a seal.

2. The wireless electronic tag of claim 1, wherein the outer housing is provided with two sealing ring grooves that are staggered, and two sealing rings are secured in the two sealing ring grooves.

3. The wireless electronic tag of claim 1, wherein a vertical mating surface is between the upper housing and the lower housing, and the sealing ring grooves are vertically arranged in the vertical mating surface.

4. The wireless electronic tag of claim 1, wherein the thermal insulated housing comprises an upper housing portion and a bottom cover pressed together to form a closed cavity for accommodating the inner housing.

5. The wireless electronic tag of claim 4, wherein a first seam between the upper housing portion and the bottom cover of the thermal insulated housing is staggered with a second seam between the upper housing and the lower housing.

6. The wireless electronic tag of claim 1, wherein the wireless electronic tag is installed onto a bracket secured to an object to be tracked.

7. The wireless electronic tag of claim 1, wherein an inner surface of the upper housing comprises a plurality of supporters.

8. A wireless electronic tag, comprising:
an outer housing comprising an upper housing and a lower housing, the outer housing being provided with sealing ring grooves to accommodate sealing rings, the upper housing and the lower housing being pressed against each other to secure the sealing rings and form a seal, an inner surface of the upper housing comprising a plurality of supporters;
a circuitry fixed to the plurality of supporters of the outer housing; and
thermal insulation media filled into a cavity of the outer housing where the circuitry is installed.

9. The wireless electronic tag of claim 8, wherein the thermal insulation media is filled in liquid form into the cavity of the outer housing, and is cured to completely wrap the circuitry.

10. The wireless electronic tag of claim 8, wherein the circuitry comprises a printed circuit board secured to the plurality of supporters.

11. The wireless electronic tag of claim 8, wherein the wireless electronic tag is installed onto a bracket secured to an object to be tracked.

12. The wireless electronic tag of claim 8, wherein the outer housing is provided with two sealing ring grooves that are staggered, and two sealing rings are secured in the two sealing ring grooves.

13. The wireless electronic tag of claim 8, wherein a vertical mating surface is between the upper housing and the lower housing, and the sealing ring grooves are vertically arranged in the vertical mating surface.

14. The wireless electronic tag of claim 8, further comprising a thermal insulated housing comprising an upper housing portion and a bottom cover pressed together to form a closed cavity for accommodating the inner housing.

15. A wireless electronic tag, comprising:
a thermal insulated housing;
an inner housing surrounded by the thermal insulated housing; and
an outer housing surrounding the thermal insulated housing, the outer housing comprising an upper housing and a lower housing, the outer housing being provided with sealing ring grooves to accommodate sealing rings, and the upper housing and the lower housing being pressed against each other to secure the sealing rings and form a seal.

16. The wireless electronic tag of claim 15, wherein the outer housing is provided with two sealing ring grooves that are staggered, and two sealing rings are secured in the two sealing ring grooves.

17. The wireless electronic tag of claim 15, wherein a vertical mating surface is between the upper housing and the lower housing, and the sealing ring grooves are vertically arranged in the vertical mating surface.

18. The wireless electronic tag of claim 15, wherein the thermal insulated housing comprises an upper housing portion and a bottom cover pressed together to form a closed cavity for accommodating the inner housing.

19. The wireless electronic tag of claim 18, wherein a first seam between the upper housing portion and the bottom cover of the thermal insulated housing is staggered with a second seam between the upper housing and the lower housing.

20. The wireless electronic tag of claim 15, further comprising a Bluetooth Low Energy chip inside the inner housing.
